(19) United States
(12) Patent Application Publication
(10) Pub. No.: US 2012/0088137 A1
(43) Pub. Date: Apr. 12, 2012

(54) NONAQUEOUS ELECTROLYTE SECONDARY BATTERY

(76) Inventor: Kensuke Nakura, Osaka (JP)

(21) Appl. No.: 13/378,210

(22) PCT Filed: Jun. 24, 2010
(86) PCT No.: PCT/JP2010/004201

§ 371 Date: Dec. 14, 2011

(30) Foreign Application Priority Data
Jun. 30, 2009 (JP) 2009-154456

(51) Int. Cl. H01M 10/0525; H01M 10/05; H01M 10/02; H01M 4/13

(52) U.S. Cl. 429/94; 429/211

(57) ABSTRACT

A battery case houses an electrode group formed by winding a positive electrode plate where a positive electrode active material layer is provided on a positive electrode current collector and a negative electrode plate where a negative electrode active material layer is provided on a negative electrode current collector with a porous insulating layer interposed therebetween. The current collectors are made of metal foil of an identical material. An end of the positive electrode current collector has a first exposed portion provided with no positive electrode active material layer. An end of the negative electrode current collector has a second exposed portion provided with no negative electrode active material layer. The exposed portions and project from the porous insulating layer in opposite directions. The first and second exposed portions and are connected to positive and negative electrode current collector plates, respectively.

### TECHNICAL FIELD

The present disclosure relates to nonaqueous electrolyte secondary batteries including electrode groups with so-called tabless structures.

### BACKGROUND ART

Lead-acid batteries are widely used in backup power sources for industrial equipment or business equipment or power sources for starters of automobiles.

In recent years, development for replacing lead-acid batteries used in backup power sources with nickel-metal hydride batteries or lithium ion secondary batteries has been activated. Replacement of lead-acid batteries with nickel-metal hydride batteries or lithium ion secondary batteries is expected to reduce the sizes of power sources by increasing the energy density and to reduce environmental loads by containing no lead.

On the other hand, at present, lead-acid batteries used as power sources for starters of automobiles do not tend to be replaced with nickel-metal hydride batteries or lithium ion secondary batteries. However, even in the case of a power source for a starter of an automobile, replacement with a lead-free battery is preferable in terms of reduction of environmental loads. In addition, for use as a power source for a starter of an automobile, a lithium ion secondary battery whose weight is lighter than that of a nickel-metal hydride battery is more promising.

A known technique for obtaining a higher power characteristic is an electrode group with a so-called tabless structure (i.e., a leadless structure). Specifically, an electrode group formed by winding a positive electrode plate and a negative electrode plate with a separator interposed therebetween has a structure in which an end of the positive electrode plate (i.e., an uncoated portion of a positive electrode material mixture layer) and an end of the negative electrode plate (i.e., an uncoated portion of a negative electrode mixture layer) project from the separator in opposite directions. An end of the positive electrode plate and an end of the negative electrode plate are respectively connected to a positive electrode current collector plate and a negative electrode current collector plate, thereby allowing current to be collected from the entire electrode plates. Consequently, discharge characteristics at large current can be enhanced.

On the other hand, a known technique for weight reduction is a technique of using aluminium foil, which has a relatively small specific gravity among metal materials with high breakdown voltages, as current collectors for a positive electrode plate and a negative electrode plate (see Patent Document 1).

### CITATION LIST

### Patent Document

PATENT DOCUMENT 1: Japanese Patent Publication No. 2002-42889

### SUMMARY OF THE INVENTION

### Technical Problem

In a conventional electrode group performing current collection from electrode plates through leads, the connection location and number of leads connected to a positive electrode plate are different from those of leads connected to a negative electrode plate. Thus, the positive and negative electrodes can be easily determined by observing the appearance of the electrode group.

In addition, in an electrode group with a tabless structure, as long as a material (e.g., aluminium foil) for a current collector of a positive electrode plate differs from a material (e.g., copper foil) for a current collector of a negative electrode plate, even if ends of the positive and negative electrode plates projecting in opposite directions are symmetric, the positive and negative electrodes can be determined based on the difference in color by observing the appearance of the electrode group.

However, in an electrode group with a tabless structure in which current collectors of positive and negative electrode plates are made of the same material, it is difficult to determine the positive and negative electrodes even by observing the appearance of the electrode group.

Assembly processes of a battery include a series of processes including a process of forming a mixture layer on a current collector to form an electrode plate, a process of winding a positive electrode plate and a negative electrode plate with a separator interposed therebetween to form an electrode group, a process of welding the electrode group to a current collector plate, and a process of inserting the electrode group in the battery case and sealing an opening of the battery case, for example. Thus, no problems generally occur in distinguishing the positive and negative electrodes of the electrode group.

However, in inspecting parts in the series of assembly processes in order to control the quality, for example, of the battery, when an electrode group formed in the process of forming an electrode group is temporarily taken out of the assembly for an inspection, and then is returned to the assembly at the next process after the inspection, it is difficult to distinguish the positive and negative electrodes from each other by observing the appearance of the electrode group. This causes an increase in time necessary for assembly of a battery.

It is, therefore, an object of the present disclosure to provide a nonaqueous electrolyte secondary battery with high power and high productivity.

### Solution to the Problem

To achieve the above object, according to the present disclosure, in a nonaqueous electrolyte secondary battery including an electrode group with a tabless structure, current collectors of positive and negative electrodes are made of an identical metal material, and the electrode group has a distinguishing means for distinguishing whether one of current collector exposed portions projecting in opposite directions is positive or negative.

Specifically, a nonaqueous electrolyte secondary battery in an aspect of the present disclosure includes an electrode group in which a positive electrode plate including a positive electrode current collector and a positive electrode active material layer provided on the positive electrode current collector, and a negative electrode plate including a negative electrode current collector and a negative electrode active material layer provided on the negative electrode current collector, are wound or stacked with a porous insulating layer interposed therebetween. The positive electrode current collector and the negative electrode current collector are made of metal foil of an identical material. An end of the positive electrode current collector has a first exposed portion where the positive electrode active material layer is not provided. An end of the negative electrode current collector has a second exposed portion where the negative electrode active material layer is not provided. The first exposed portion of the positive electrode current collector and the second exposed portion of the negative electrode current collector project from the porous insulating layer in opposite directions. The electrode group has a distinguishing means for distinguishing whether an exposed portion projecting from the porous insulating layer is the first exposed portion or the second exposed portion.

With this structure, the exposed portions projecting from the porous insulating layer in opposite directions can be easily determined only by observing the appearance of the electrode group with a tabless structure in which the current collectors of the positive and negative electrodes are made of the same material. As a result, the time necessary for battery assembly can be reduced.

In another aspect of the present disclosure, the distinguishing means preferably has a configuration in which the first exposed portion and the second exposed portion differ from each other in form or color.

The distinguishing means may have a configuration in which the first exposed portion has a width different from that of the second exposed portion. Alternatively, the distinguishing means has a configuration in which the first exposed portion may have a shape different from that of the second exposed portion. Alternatively, the distinguishing means has a configuration in which at least one of the first exposed portion or the second exposed portion has a punched portion.

Preferably, in another aspect of the present disclosure, the positive electrode plate and the negative electrode plate are wound with the porous insulating layer interposed therebetween, an outermost periphery of the electrode group is fixed with a fixing member, and the distinguishing means has a configuration in which the fixing member provided near the first exposed portion and the fixing member provided near the second exposed portion differ from each other in form, color, or number.

In another aspect of the present disclosure, the positive electrode current collector and the negative electrode current collector are preferably made of metal foil of aluminium or an aluminium alloy.

### Advantages of the Invention

According to the present disclosure, a distinguishing means for distinguishing whether one of current collector exposed portions projecting in opposite directions is positive or negative is provided in an electrode group with a tabless structure in which positive and negative current collectors are made of the same material, thereby easily distinguishing positive and negative electrodes from each other by observing the appearance of the electrode group. Accordingly, the time necessary for battery assembly can be reduced, thus achieving a nonaqueous electrolyte secondary battery with high power and high productivity.

### BRIEF DESCRIPTION OF THE DRAWINGS

FIG. 1 is a cross-sectional view schematically illustrating a structure of a nonaqueous electrolyte secondary battery according an embodiment of the present disclosure.

FIG. 2 is a flowchart showing general assembly processes of a nonaqueous electrolyte secondary battery.

FIG. 3 is a plan view showing a slit process of a hoop-shaped current collector.

FIGS. 4A and 4B are plan views illustrating structures of a positive electrode plate and a negative electrode plate, respectively.

FIGS. 5A and 5B are plan views illustrating structures of a positive electrode plate and a negative electrode plate of the embodiment of the present disclosure.

FIG. 6 is a plan view illustrating a structure of a positive electrode plate or a negative electrode plate according to another embodiment of the present disclosure.

FIG. 7 is a perspective view illustrating a structure of an electrode group according to another embodiment of the present disclosure.

### DESCRIPTION OF EMBODIMENTS

Embodiments of the present disclosure will be described hereinafter with reference to the drawings. The present disclosure is not limited to the following embodiments. Various changes and modifications may be made without departing from the scope of the present invention, and the following embodiments may be combined as necessary.

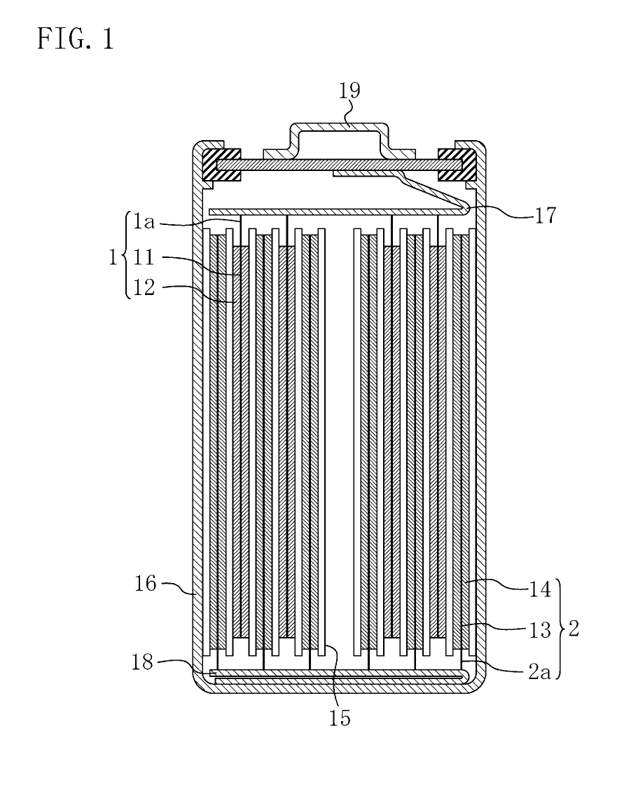

FIG. 1 is a cross-sectional view schematically illustrating a structure of a nonaqueous electrolyte secondary battery according an embodiment of the present disclosure.

As illustrated in FIG. 1, a battery case 16 houses an electrode group obtained by winding a positive electrode plate 1 in which a positive electrode active material layer 12 is formed on a positive electrode current collector 11, and a negative electrode plate 2 in which a negative electrode active material layer 14 is formed on a negative electrode current collector 13 is formed, with a porous insulating layer (separator) 15 interposed therebetween. The positive electrode current collector 11 and the negative electrode current collector 13 are made of metal foil of the same material.

An end of the positive electrode current collector 11 has a first exposed portion la provided with no positive electrode active material layer 12. An end of the negative electrode current collector 13 has a second exposed portion 2a provided with no negative electrode active material layer 14. The first exposed portion 1a of the positive electrode current collector 11 and the second exposed portion 2a of the negative electrode current collector 13 project from the porous insulating layer 15 in opposite directions. The first exposed portion 1a of the positive electrode current collector 11 is connected to the positive electrode current collector plate 17. The second exposed portion 2a of the negative electrode current collector 13 is connected to the negative electrode current collector plate 18. An opening of the battery case 16 is sealed by a sealing plate 19.

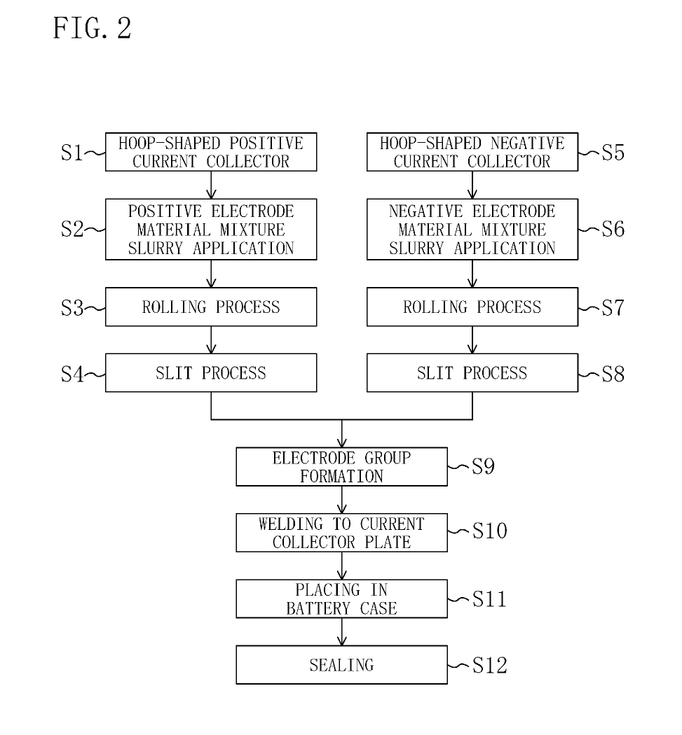

FIG. 2 is a flowchart showing general assembly processes of a nonaqueous electrolyte secondary battery.

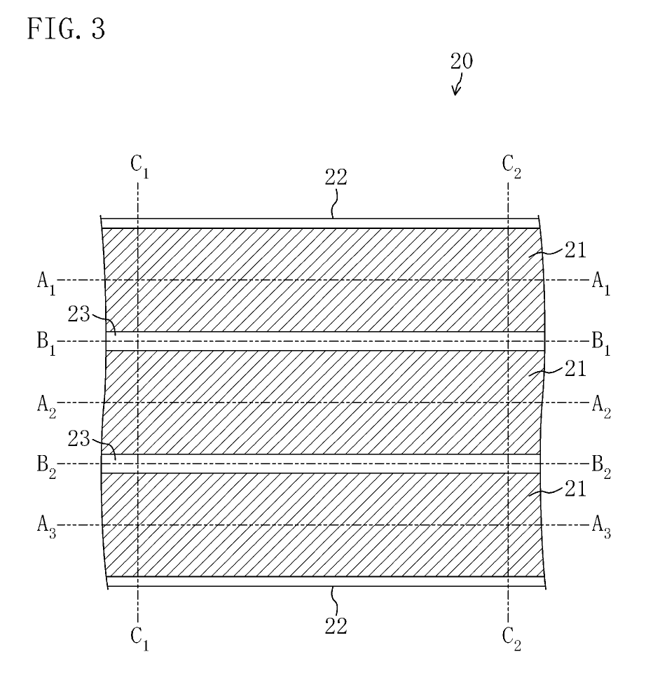

As shown in FIG. 2, a hoop-shaped positive electrode current collector is prepared (step S1). Next, positive electrode material mixture slurry containing a positive electrode active material, a binder, and a conductive agent is applied onto the hoop-shaped positive electrode current collector (step S2). In this step, as illustrated in FIG. 3, exposed portions 22 and 23 on which the positive electrode material mixture slurry 21 is not provided, are formed in the hoop-shaped current collector 20 along the longitudinal direction of the current collector 20.

Then, the positive electrode material mixture slurry applied onto the hoop-shaped positive electrode current collector is dried, and then the hoop-shaped positive electrode current collector is rolled (step S3). Thereafter, as illustrated in FIG. 3, the hoop-shaped current collector 20 is slit along lines A₁-A₁, A₂-A₂, A₃-A₃, B₁-B₁, and B₂-B₂ in the longitudinal direction, and then further slit along lines C₁-C₁ and C₂-C₂ in the width direction (step S4), thereby forming positive electrode plates 1 each having a predetermined width and a predetermined length. The pattern in applying the positive electrode material mixture slurry 21 onto the hoop-shaped positive electrode current collector 20 is not limited to that shown in FIG. 3, and may be appropriately changed according to the number of positive electrode plates 1, for example.

In a manner similar to that of the positive electrode plates 1, negative electrode plates 2 each having a predetermined width and a predetermined length can be formed by applying negative electrode material mixture slurry onto a hoop-shaped negative electrode current collector (steps S5 and S6), and then performing a rolling process (step S7) and a slit process (step S8).

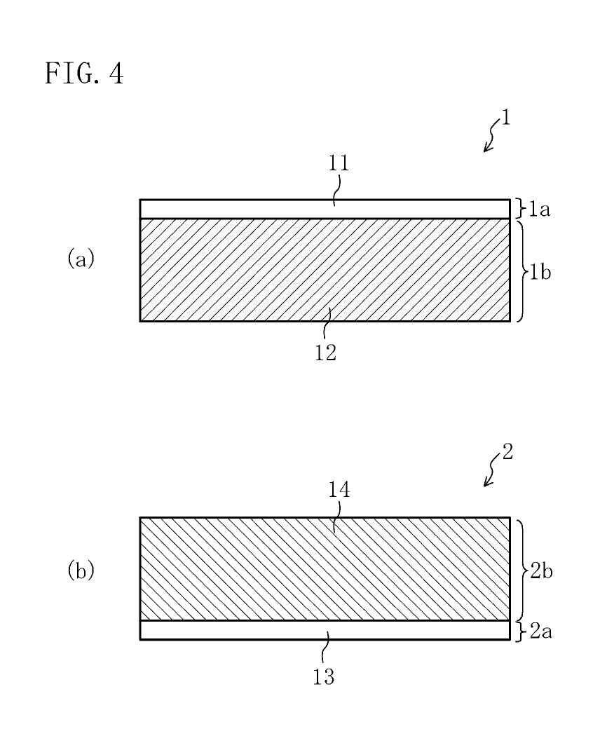

FIGS. 4A and 4B are plan views illustrating structures of a positive electrode plate 1 and a negative electrode plate 2, respectively, formed in the manner described above. The positive electrode plate 1 includes: a coated portion lb in which the positive electrode active material layer 12 is formed on the positive electrode current collector 11; and a first exposed portion 1a in which the positive electrode active material layer 12 is not formed and the positive electrode current collector 11 is exposed. The negative electrode plate 2 includes: a coated portion 2b in which the negative electrode active material layer 14 is formed on the negative electrode current collector 13; and the second exposed portion 2a in which the negative electrode active material layer 14 is not formed and the negative electrode current collector 13 is exposed.

Then, the positive electrode plate 1 and the negative electrode plate 2 are wound with a porous insulating layer (separator) 15 interposed therebetween, thereby forming an electrode group with a tabless structure (step S9). In this step, the first exposed portion 1a of the positive electrode current collector 11 and the second exposed portion 2a of the negative electrode current collector 13 project from the porous insulating layer 15 in opposite directions.

Subsequently, the first exposed portion 1a of the positive electrode current collector 11 is welded to a positive electrode current collector plate 17, and the second exposed portion 2a of the negative electrode current collector 13 is welded to a negative electrode current collector plate 18 (step S10). Thereafter, the electrode group and a nonaqueous electrolyte are placed in a battery case 16 (step S11), and then an opening of the battery case 16 is sealed (step S12). In this manner, a nonaqueous electrolyte secondary battery is fabricated.

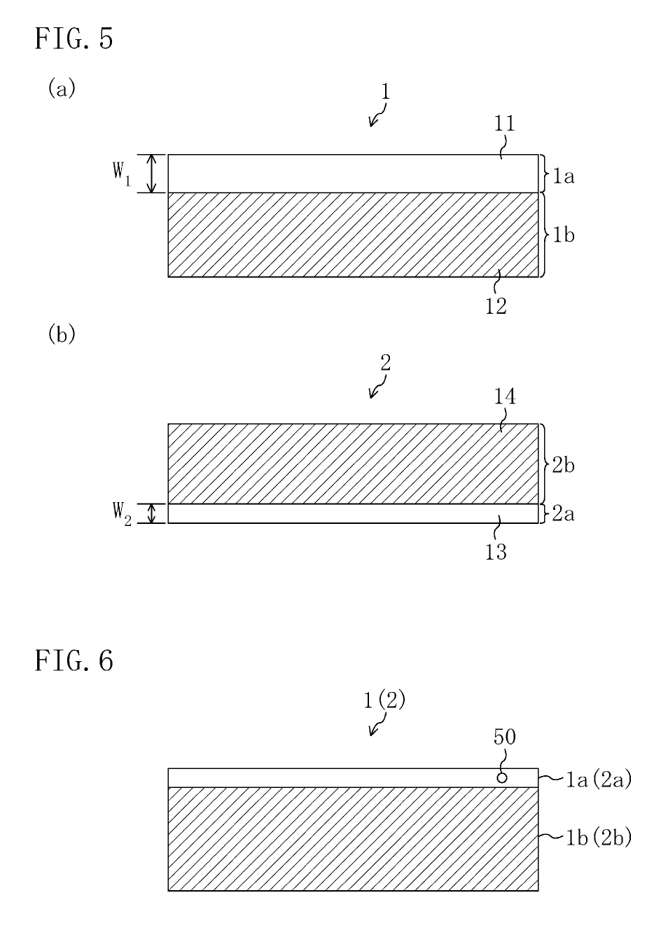

FIGS. 5A and 5B are plan views illustrating structures of the positive electrode plate 1 and the negative electrode plate 2 of this embodiment. As illustrated in FIGS. 5A and 5B, the width W₁ of the first exposed portion 1a of the positive electrode current collector 11 is different from the width W₂ of the second exposed portion 2a of the negative electrode current collector 13. The positive and negative electrode plates 1 and 2 with the above structures are wound with the porous insulating layer 15 interposed therebetween, thereby forming an electrode group with a tabless structure. In this structure, it is easily determined whether an exposed portion projecting from the porous insulating layer 15 is the first exposed portion 1a or the second exposed portion 2a based on the difference between the widths Wᵢ and W₂. Specifically, the first exposed portion 1a and the second exposed portion 2a can be configured to have different widths W₁ and W₂ as a distinguishing means for distinguishing the exposed portions of the positive and negative electrode current collectors projecting from the porous insulating layer 15 in opposite directions.

Even if the electrode group having such a distinguishing means is temporarily taken out of the assembly for an inspection, the positive and negative electrodes of the electrode group can be easily distinguished from each other by observing the appearance of the electrode group when the electrode group is returned to the assembly at the next process after the inspection.

The different widths W₁ and W₂ of the first exposed portion 1a and the second exposed portion 2a can be easily obtained by adjusting the widths of the exposed portions 22 and 23 of the current collector 20 provided with no material mixture slurry 21 in the slit processes (steps S4 and S8) shown in FIG. 3. Specifically, in the series of assembly processes shown in FIG. 2, a distinguishing means for distinguishing whether an exposed portion projecting from the porous insulating layer 15 is the first exposed portion 1a or the second exposed portion 2a can be provided. Accordingly, fabrication cost hardly increases by providing the distinguishing means.

The distinguishing means allows the positive and negative electrodes of the electrode group to be easily visually distinguished from each other. Alternatively, the positive and negative electrodes can be automatically distinguished by image processing on an image obtained with a camera.

The above distinguishing means employs a configuration in which the width W₁ of the first exposed portion 1a is different from the width W₂ of the second exposed portion 2a. However, the present disclosure is not limited to this configuration. In the series of assembly processes shown in FIG. 2, the first exposed portion 1a and the second exposed portion 2a may be configured to have different forms (e.g., shapes, sizes, or patterns) or different colors. This configuration can also provide a distinguishing means for distinguishing the first exposed portion 1a and the second exposed portion 2a to the electrode group with a tabless structure.

Specifically, as illustrated in FIG. 6, as the distinguishing means, at least one of the first exposed portion 1a of the positive electrode plate 1 or the second exposed portion 2a of the negative electrode plate 2 may have a punched portion 50. This punched portion 50 can be easily formed by performing a punching process after the slit processes (steps S4 and S8) shown in FIG. 3.

The shape of the punched portion 50 is not specifically limited, and may be circular, rectangular, or other shapes. The punched portion 50 may be formed in each of the first exposed portion 1a and the second exposed portion 2a. In this case, the shapes and numbers of the punched portions 50 are made different between the first exposed portion 1a and the second exposed portion 2a, thereby providing a distinguishing means for the positive and negative electrodes.

The distinguishing means may be provided by performing etching or plating on at least one of the first exposed portion 1a or the second exposed portion 2a to provide unevenness on the surface of the exposed portion. Alternatively, at least one of the first exposed portion 1a or the second exposed portion 2a may be covered with an insulating layer of ceramics or resin, for example.

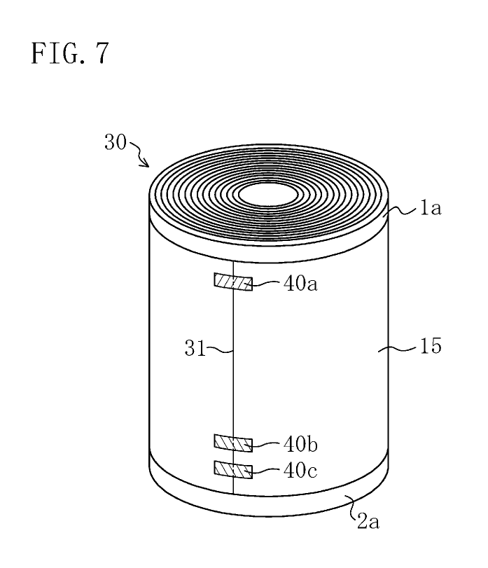

FIG. 7 is a perspective view illustrating a structure of an electrode group 30 according to another embodiment of the present disclosure.

As illustrated in FIG. 7, an electrode group 30 obtained by winding a positive electrode plate 1 and a negative electrode plate 2 with a porous insulating layer 15 interposed therebetween, has an outermost periphery 31 fixed with fixing members 40a, 40b, and 40c. The number of fixing members 40a provided near a first exposed portion 1a is different from that of fixing members 40b and 40c near a second exposed portion 2a, thereby providing a distinguishing means for distinguish whether an exposed portion projecting from the porous insulating layer 15 is the first exposed portion 1a or the second exposed portion 2a.

Providing the different numbers of fixing members can be easily performed in the electrode group formation step (step S9) shown in FIG. 2. Accordingly, a cost increase hardly occurs by providing the distinguishing means.

Materials for the fixing members are not specifically limited, and may be an insulating tape containing polyethylene, polypropylene, polyimide, or polyphenylene sulfide, as a main component, or an epoxy- or acrylic-based adhesive, for example.

In stead of providing the fixing members whose numbers differ between the locations near the first exposed portion 1a and the second exposed portion 2a, the fixing members near the first exposed portion 1a and the fixing members near the second exposed portion 2a may have different forms (e.g., shapes, sizes, or patterns) or different colors.

In this embodiment, the positive electrode current collector 11 and the negative electrode current collector 13 are made of metal foil of the same material. However, the materials for these collectors are not specifically limited, and may be aluminium, an aluminium alloy, stainless steel, titanium, nickel, or copper, for example.

In this embodiment, materials and processes for the components of the nonaqueous electrolyte secondary battery are not specifically limited, and may be as follows.

The positive electrode active material may be lithium combined metal oxide. Examples of the lithium combined metal oxide include LiₓCoO₂, LiₓNiO₂, LiₓMnO₂, or LiₓCo_{y}Ni_{1-y}O₂. Examples of a material for the binder for the positive electrode material mixture slurry include polyvinylidene difluoride (PVDF), polytetrafluoroethylene, polyethylene, and polypropylene. Examples of a material for the conductive agent for the positive electrode material mixture slurry include graphite and carbon black such as acetylene black.

Examples of a material for the negative electrode active material include a carbon material such as graphite, silicon, tin, and a compound of these materials. Examples of a material for the binder for the negative electrode material mixture slurry include styrene-butylene copolymer rubber and polyacrylic acid.

Examples of a material for the separator include polypropylene and polyethylene. Examples of a material for the nonaqueous electrolyte include a liquid or gelled material and a solid material (a solid polymer electrolyte).

The present disclosure has been described based on the foregoing preferred embodiments. These embodiments do not limit the present disclosure, and may be variously changed or modified. For example, in the foregoing embodiments, as a distinguishing means for distinguishing whether an exposed portion projecting from the porous insulating layer 15 is the first exposed portion 1a or the second exposed portion 2a, the exposed portions of the current collectors differ in form or color, or the fixing members fixing the outermost periphery of the electrode group differ in form, color, or number. Alternatively, a portion of the porous insulating layer 15 appearing near the first exposed portion 1a and a portion of the porous insulating layer 15 appearing near the second exposed portion 2a may differ in shape or color.

### INDUSTRIAL APPLICABILITY

A nonaqueous electrolyte secondary battery according to the present disclosure is useful for power sources for household appliances, electric vehicles, and large tools, for example.

### DESCRIPTION OF REFERENCE CHARACTERS

1 positive electrode plate
1a first exposed portion
1b coated portion
2 negative electrode plate
2a second exposed portion
2b coated portion
11 positive electrode current collector
12 positive electrode active material layer
13 negative electrode current collector
14 negative electrode active material layer
15 porous insulating layer
16 battery case
17 positive electrode current collector plate
18 negative electrode current collector plate
19 sealing plate
20 hoop-shaped current collector
21 material mixture slurry
22, 23 exposed portion
30 electrode group
31 outermost periphery
40a, 40b, 40c fixing member
50 punched portion

1. A nonaqueous electrolyte secondary battery, comprising
an electrode group in which a positive electrode plate including a positive electrode current collector and a positive electrode active material layer provided on the positive electrode current collector, and a negative electrode plate including a negative electrode current collector and a negative electrode active material layer provided on the negative electrode current collector, are wound or stacked with a porous insulating layer interposed therebetween, wherein the positive electrode current collector and the negative electrode current collector are made of metal foil of an identical material,
an end of the positive electrode current collector has a first exposed portion where the positive electrode active material layer is not provided,
an end of the negative electrode current collector has a second exposed portion where the negative electrode active material layer is not provided,
the first exposed portion of the positive electrode current collector and the second exposed portion of the negative electrode current collector project from the porous insulating layer in opposite directions, and
the electrode group has a distinguishing means for distinguishing whether an exposed portion projecting from the porous insulating layer is the first exposed portion or the second exposed portion.

2. The nonaqueous electrolyte secondary battery of claim 1, wherein the distinguishing means has a configuration in which the first exposed portion and the second exposed portion differ from each other in form or color.

3. The nonaqueous electrolyte secondary battery of claim 2, wherein the distinguishing means has a configuration in which the first exposed portion has a width different from that of the second exposed portion.

4. The nonaqueous electrolyte secondary battery of claim 2, wherein the distinguishing means has a configuration in which the first exposed portion has a shape different from that of the second exposed portion.

5. The nonaqueous electrolyte secondary battery of claim 2, wherein the distinguishing means has a configuration in which at least one of the first exposed portion or the second exposed portion has a punched portion.

6. The nonaqueous electrolyte secondary battery of claim 1, wherein the positive electrode plate and the negative electrode plate are wound with the porous insulating layer interposed therebetween,
an outermost periphery of the electrode group is fixed with a fixing member, and
the distinguishing means has a configuration in which the fixing member provided near the first exposed portion and the fixing member provided near the second exposed portion differ from each other in form, color, or number.

7. The nonaqueous electrolyte secondary battery of claim 6, wherein the fixing member is made of an insulating tape.

8. The nonaqueous electrolyte secondary battery of claim 1, wherein the positive electrode current collector and the negative electrode current collector are made of metal foil of aluminium or an aluminium alloy.

9. The nonaqueous electrolyte secondary battery of claim 1, wherein the first exposed portion of the positive electrode current collector is connected to a positive electrode current collector plate, and
the second exposed portion of the negative electrode current collector is connected to a negative electrode current collector plate.

10. The nonaqueous electrolyte secondary battery of claim 1, wherein the nonaqueous electrolyte secondary battery is a lithium ion secondary battery.
